(19) United States
(12) Patent Application Publication
(10) Pub. No.: US 2004/0223906 A1
(43) Pub. Date: Nov. 11, 2004

(54) Lithium nickel cobalt oxides and their methods of fabrication

(76) Inventors: Chuanfu Wang, Shenzhen (CN); Zhanfeng Jiang, Shenzhen (CN); Junqing Dong, Shenzhen (CN)

Correspondence Address: EMIL CHANG, LAW OFFICES OF EMIL CHANG, 874 JASMINE DRIVE, SUNNYDALE, CA, 94086, US

(21) Appl. No.: 10/841,760

(22) Filed: May 8, 2004

Related U.S. Application Data
(63) Continuation-in-part of application No. 10/717,236, filed on Nov. 19, 2003.
(63) Continuation-in-part of application No. 10/733,018, filed on Dec. 10, 2003.
(63) Continuation-in-part of application No. 10/770,630, filed on Feb. 2, 2004.

(30) Foreign Application Priority Data
Aug. 15, 2003 (CN) 03140216.X
Aug. 15, 2003 (CN) 03140196.1
May 9, 2003 (CN) 03126555.3
Jun. 23, 2003 (CN) 03139607.0
Oct. 28, 2003 (CN) 200310111966.4

(51) Int. Cl. C01G 51/04; C01G 53/04; H01M 4/52

(52) U.S. Cl. 423/594.4; 429/231.1; 429/231.3; 429/223; 423/594.6

(57) ABSTRACT

This invention provides improved lithium nickel cobalt oxide comprising of lithium nickel cobalt oxide granules with chemical formula LiNi₁₋ₓCoₓO₂, coated with a layer of lithium cobalt oxide granules with chemical formula LiCoO₂. This improved lithium nickel cobalt oxide, particularly when 0.15<x<0.30, exhibits the favorable electrochemical properties of both the lithium nickel cobalt oxide granules and those of the lithium cobalt oxide granules. To fabricate said improved lithium nickel cobalt oxide, the lithium nickel cobalt oxide granules are first made by calcining a mixture of Ni₁₋ₓCo_{0.x}(OH)₂ and Li₂CO₃. The lithium nickel cobalt oxide granules are then added and stirred into a mixture of lithium and cobalt salts in de-ionized water and acrylic acid as the chelation agent to obtain a get. This gel is dried and calcined to form the improved lithium nickel cobalt oxide.

### CROSS REFERENCE

This application claims priority from the following Chinese patent applications:

“Active Materials for the Positive Electrodes of Anhydrous Rechargeable Batteries, Their Methods of Fabrication and Anhydrous Rechargeable Batteries Using said Materials ”, filed on Aug. 15, 2003, and having a Chinese Application No. 03140216.x.;

“A Type of Lithium Ion Rechargeable Battery and Methods of Fabrication for Its Positive Electrodes ”, filed on Aug. 15, 2003 and having a Chinese Application No. 03140196.1;

“Materials for the Positive Electrodes of Anhydrous Rechargeable Batteries and Their Methods of Fabrication ”, filed on May 9, 2003 and having a Chinese Application No. 03126555.3;

“Stacked Lithium Secondary Battery ”, filed on Jun. 23, 2003 and having a Chinese Application No. 03139607.0; and

“Lithium Ion Rechargeable Battery ”, filed on Oct. 28, 2003 and having a Chinese Application No. 200310111966.4.

All of the above applications are incorporated herein by reference.

This application is a continuation-in-part of the following U.S. patent applications entitled:

“Methods for Preparation from Carbonate Precursors the Compounds of Lithium Transition Metal Oxide ”, filed on Nov. 19, 2003 having a U.S. patent application Ser. No. 10/717,236;

“Lithium Ion Secondary Batteries ”, filed on Dec. 10, 2003 and having a U.S. patent application Ser. No.10/733,018;

“Compounds of Lithium Nickel Cobalt Metal Oxide and the Methods of Their Fabrication ”, filed on Apr. 14, 2004 and having a U.S. patent application Ser. No.______ yet to be assigned______; and

“Stacked-Type Lithium-ion Rechargeable Battery ”, filed on Feb. 2, 2004, and having a U.S. patent application Ser. No. 10/770,630.

### FIELD OF INVENTION

This invention relates to a type of improved lithium nickel cobalt oxide and its method of fabrication. Particularly, it relates to lithium nickel cobalt oxide granules coated with lithium cobalt oxide granules that can be used as material for the positive electrodes of anhydrous rechargeable batteries.

### BACKGROUND

At present, LiCoO₂ is the most widely used material for positive electrodes of lithium ion rechargeable batteries. However, its use of LiCoO₂ in batteries is limited by the scarcity and high price of cobalt. LiNiO₂ is considered to be one of the most competitive substitutes for LiCoO₂. Its theoretical capacity is close to LiCoO₂, its self-discharge rate is low, and it does not contaminate the environment. Its price and availability is superior to LiCoO₂. However, the specifications for the compounding of LiNiO₂ are restrictive. Moreover, LiNiO₂ is not as stable in heat and safety issues can easily arise. As a result, attempts have been made to add elements such as Co, Mn, Ga, Al, or F to increase the stability of the material, its charge and discharge capacity, and cycle life.

Among the materials considered, lithium nickel cobalt oxide, LiNi₁₋ₓCoₓO₂ with 0.15<x<0.30, (hereinafter “LiNi₁₋ₓCoₓO₂”) doped with cobalt exhibits good overall properties. The reversible capacity of the LiNi₁₋ₓCoₓO₂ material can reach above 180mAh/g, far higher then LiCoO₂ (approximately 140mAh/g) and LiMn₂O₄ (approximately 120mAh/g). The higher irreversibility capacity of the LiNi₁₋ₓCoₓO₂ can also be utilized to provide the lithium ion for the formation of the SEI membrane of the negative electrode; thereby lowering the excess dosage of the positive electrode material. Therefore, LiNi₁₋ₓCoₓO₂ not only possesses the characteristics of LiCoO₂, i.e., the easy composition and stable characteristics, it also has the high specific capacity and low cost advantages of LiNiO₂.

Although LiNi₁₋ₓCoₓO₂ material has many advantages, it also has some weaknesses that are the barriers to the large-scale commercialization of the material for use as positive electrodes of batteries. The heat stability characteristics of a material used for positive electrodes during charging is an important factor affecting the safety property of batteries. When the positive electrode in is in an overcharged state, it can form vapors from the oxidation of the electrolyte. This increases the internal pressure and internal resistance of the battery. When lithium ion detaches, the heat stability characteristics of LiNiO₂ material becomes worse than LiCoO₂ and LiMn₂O₄. At approximately 200° C, Li_{0.3}NiO₂ will decompose emitting oxygen. Li_{0.4}CoO₂ will decompose at approximately 240° C. while the decomposition temperature of λ-MnO₂ is approximately 385° C.

Even if LiNi₁₋ₓCoₓO₂ does not undergo changes during the charging and discharging cycles, slight twisting and bending of the octahedral MO6 (M═Ni, Co) still occurs during the attachment and detachment of the lithium ion. This phenomenon, and the continual expansion and contraction of the crystallite can both cause the granules to break and pulverize. In addition, during charging, the Ni and Co ion is placed at +4 value with higher reaction activity such that they can react easily with the organic solvent causing the dissolving of the M ion in the MO₂ layer. All the above stated factors will affect the cycle properties of batteries whose positive electrodes are made with LiNi₁₋ₓCOₓO₂. In addition, when discharging with higher currents, the increase in the speed of twisting and bending of the crystallites prevents the attaching and detaching of the lithium ion resulting in the lowering of the discharge capacity of the battery. Therefore, the large current discharge characteristics of batteries with positive electrodes made with LiNi₁₋ₓCoₓO₂ are slightly worse than those made with LiCoO₂.

Another problem that LiNi₁₋ₓCoₓO₂ presents is its storage property. Since its alkalinity is higher, it reacts with the water and carbon dioxide in the air during storage easier resulting in the deterioration of the properties of the material. The reaction process is:

LiNi₁₋ₓCOₓO₂+y/2CO₂+y/4O₂—H₂O—>Li_{1-y}Ni₁₋ₓCoₓO₂+y/2Li₂C0₃.

Even at room temperature, the Li ion in Li Ni₁₋ₓCoₓO₂ attaches and detaches to form lithium carbonate at the surface of its body. Research shows that when the LiNi₁₋ₓCoₓO₂ is placed at 25° C. and 55% RH of air, the transformation ratio into lithium carbonate is directly proportional to the square root of the amount of time it is placed in air. After placing in air for 500 hours, 8% of the Li will be transformed into lithium carbonate. At 675□, over 70% of the Li would be detached from the body structure and react with the carbon dioxide to form lithium carbonate.

The above stated harmful reactions and the process of twisting and bending of the crystallite structure first occur at the surface of the material. Therefore, industry has begun to conduct research on surface treatments for LiNi₁₋ₓCoₓO₂ to increase its heat stability and improve its large current discharge characteristics. Japanese Patent Publication 2001-143708 uses an aluminum coating method to increase the stability LiNi₁₋ₓCoₓO₂. At below 20□, after coating with 15% to 20% molar percentage of aluminum, the safety of the battery is retained even after overcharging to 10V.

Although though the coating of LiNi₁₋ₓCoₓO₂ with metal ions can increase the heat stability of the material, and the large current discharge characteristics and resistance to overcharging, the cost of this gain in battery performance is the lowering of the discharge specific capacity. When the coating with metal ions increases to adequately improve the heat stability, large current discharge characteristics, and resistance to overcharging of LiNi₁₋ₓCoₓO₂, the specific discharge capacity of the material is very much lowered.

Due to the limitations of the prior art, it is therefore desirable to have novel methods of surface treatments for LiNi₁₋ₓCoₓO₂ such that batteries with made with the LiNi₁₋xCoxO2 that have been surface treated exhibit better heat stability, improved large current characteristics, and resistance to overcharging without loosing their specific discharge capacity.

### SUMMARY OF INVENTION

The object of this invention is to disclose an improved lithium nickel cobalt oxide with improved electrochemical properties such that when said improved lithium nickel cobalt oxides are used as the material for the positive electrodes of rechargeable batteries, the batteries exhibit improved heat stability and large current characteristics, charge and discharge cycle properties, and, storage properties while retaining their high specific discharge capacities.

Another object of this invention is to disclose the novel method of fabrication for said improved lithium nickel cobalt oxide.

The present invention relates to improved lithium nickel cobalt oxide comprising of lithium nickel cobalt oxide granules with chemical formula LiNi₁₋ₓCoₓO₂ that are coated with a layer of lithium cobalt oxide granules with chemical formula LiCoO₂. To fabricate said improved lithium nickel cobalt oxide, the lithium nickel cobalt oxide granules are first made by calcining a mixture of Ni₁₋ₓCo_{0.x}(OH)₂ and Li₂CO₃. The lithium nickel cobalt oxide granules are then added and stirred into a mixture of lithium and cobalt salts in de-ionized water and acrylic acid as the chelation agent until a gel is obtained. This gel is dried and calcined to form the improved lithium nickel cobalt oxide.

An advantage of this invention is that the improved lithium nickel cobalt has excellent electrochemical properties. When this improved nickel cobalt oxide is used as the material for the positive electrodes of rechargeable batteries, the batteries exhibit improved heat stability and large current characteristics, charge and discharge cycle properties, and storage properties without lowering their specific discharge capacities.

### DETAILED DESCRIPTION OF THE PREFERRED EMBODIMENTS

This invention provides a type of material for positive electrodes of anhydrous rechargeable batteries, LiNi₁₋ₓCoₓO₂ granules coated uniformly with a layer of LiCoO₂ granules. In embodiments of this invention, to ensure that the LiCoO₂ can form a uniform layer of shell on the surface of the granules of LiNi₁₋ₓCoₓO₂ such that said improved LiNi₁₋ₓCoₓO₂ material has better electrochemical properties, the preferred granule diameter of the LiNi₁₋ₓCoₓO₂ granules is between 6 μm to 10 μm and the preferred granule diameter of the LiCoO₂ granules used for the coating is under 1 μm. The molar percentage of the LiCoO₂ granules with the LiNi₁₋ₓCoₓO₂ granules is between 1% and 15%. The preferred molar percentage of the LiCoO₂ granules with the LiNi₁₋ₓCoₓO₂ granules is between 5% and 10%.

An embodiment of the fabrication method for a type of material for the positive electrodes of anhydrous rechargeable batteries, comprising the following steps:

(1) Ni₁₋ₓCo_{0.x}(OH)₂ (0.15<x<0.30) with granule diameters between 4 μm and 8 μm and Li₂CO₃ is uniformly mixed in the molar ratio (Ni+Co): Li=1: 1.05. The mixture is calcined in oxygen atmosphere at 600° C. to 750° C. for 4 hours to 8 hours and then at 750° C. to 900° C. for 10 hours to 20 hours to obtain the LiNi₁₋ₓCoₓO₂, (0.15<x<0.30), with uniform structure and granule diameters between 6 μm and 10 μm.

(2) Soluble lithium and cobalt salts are mixed and dissolved in de-ionized water where the molar ratio of Li:Co=1.01:1. A chelation agent such as acrylic acid is added where the molar ratio of acrylic acid: (Li+Co)=2:1.

(3) At 60° C. to 100° C., the prepared LiNi₁₋ₓCoₓO₂ granules (0.15<x<0.30) is stirred and slowly added into the lithium and cobalt solution containing acrylic acid such that the final molar ratio of LiNi₁₋ₓCoₓO₂: LiCoO₂=1: between 0.01 and 0.15. This mixture is stirred continuously until a blue-black color gel is obtained.

(4) After drying the get at 80° C. to 120° C., it is calcined in air at 600° C. to 850° C. for 0.5 hours to 2 hours to obtain LiNi₁₋ₓCoₓO₂ (0.15<x<0.30) coated with 1% to 15% LiCoO₂.

To examine the electrochemical properties of the improved lithium nickel cobalt oxide of this invention, the following comparison example and embodiments are fabricated, made into the material for the positive electrodes of batteries. The performance, characteristics and properties of the batteries are then tested.

### COMPARISON EXAMPLE

Ni_{0.8}Co_{0.2}(OH)₂ with granule diameters between 71 μm and 81 μm and Li₂CO₃ are uniformly mixed in the molar ratio (Ni+Co): Li=1: 1.05. The mixture is calcined in oxygen atmosphere at 650° C. for 6 hours and then at 800° C. for 16 hours to obtain LiNi_{0.8}Co_{0.2}O₂ with uniform structure and granule diameters between 8 μm and 91 μm.

### Embodiment 1

Soluble lithium and cobalt salts are mixed and dissolved in the molar ratio of Li:Co=1.01:1 in de-ionized water and acrylic acid is then added as the chelation agent where the molar ratio of acrylic acid: (Li+Co)=2:1. At 80° C., LiNi_{0.8}Co_{0.2}O₂ prepared in the manner as stated in the Comparison Example is then stirred and slowly added to the mixture such that the final molar ratio of LiNi₁₋ₓCoₓO₂: LiCoO₂=1: 0.01. The mixture is continuously stirred until a blue-black color gel is obtained. After drying the gel at 120° C., the gel is calcined in air at 750° C. for 1 hour to obtain LiNi_{0.8}Co_{0.2}0₂ granules coated with 1% LiCoO₂ granules.

### Embodiment 2

The experimental process is the same as Embodiment 1. The difference is that the molar ratio of LiNi_{0.8}Co0.2O₂:LiCoO₂=1:0.05. In this embodiment, LiNi_{0.8}Co_{0.2}O₂ is coated with 5% LiCoO₂.

### Embodiment 3

The experimental process is the same as Embodiment 1. The difference is that the molar ratio of LiNi_{0.8}Co_{0.2}O₂:LiCoO₂=1:0.10. In this embodiment, LiNi_{0.8}Co_{0.2}O₂ is coated with 10% LiCoO₂.

### Embodiment 4

The experimental process is the same as Embodiment 1. The difference is that the molar ratio of LiNi_{0.8}Co_{0.2}O₂:LiCoO₂=1:0.15. In this embodiment, LiNi_{0.8}Co_{0.2}O₂ is coated with 15% LiCoO₂.

### Testing of Material

The materials from the Comparative Example and each embodiment are separately made into positive electrodes. Batteries are made with each of these positive electrodes and different discharge currents and charge and discharge cycles are tested. Table I shows the electrochemical properties of the materials fabricated in Comparison Example and Embodiments 1 through 4. The ratios, IC/0.5C, 2C/0.5C, and 3C/0.5C, in Table 1 are the ratios of the discharge currents.

TABLE 1
The Electrochemical Properties of the Material for the Positive Electrodes of the
Embodiments

| | | | | | | 100 cycle |
|---|---|---|---|---|---|---|
| | LiCoO₂ | 0.5 C Discharge | Large Current Discharge | | | remaining |
| | Coating | Specific | Characteristic/% | | | capacity |
| Experiment | Amount/% | Capacity/mAh/g | 1 C/0.5 C | 2 C/0.5 C | 3 C/0.5 C | rate % |
| Comparison | 0 | 181 | 95 | 86 | 65 | 84 |
| Example | | | | | | |
| Embodiment 1 | 1 | 181 | 95 | 87 | 68 | 88 |
| Embodiment 2 | 5 | 180 | 98 | 94 | 80 | 95 |
| Embodiment 3 | 10 | 179 | 98 | 95 | 82 | 96 |
| Embodiment 4 | 15 | 168 | 99 | 96 | 83 | 96 |

After charging, the batteries are anatomized and the material for the positive electrode is scraped and dried and the decomposition temperature of the material for positive electrode after charging is tested. The testing uses Differential Scanning Calorimeter (DSC) to measure 5 the decomposition temperature and the rate of increase in temperature is 5° C. The results of the testing are shown in Table 2.

TABLE 2
The Decomposition Temperature of the Material for the Positive Electrodes of
the Embodiments After Charging

| | Comparison | | | | |
|---|---|---|---|---|---|
| Experiment | Example | Embodiment 1 | Embodiment 2 | Embodiment 3 | Embodiment 4 |
| LiCoO₂ Coating | 0 | 1 | 5 | 10 | 15 |
| Amount % | | | | | |
| Decomposition | 198.2 | 200.7 | 235.0 | 236.5 | 238.4 |
| Temperature/□ | | | | | |

The fabricated materials for the positive electrode are placed in air environment at 20° C. and humidity of 55% Rh and its lithium content is tested with atomic absorption spectrophotometer. The results of the testing are shown in Table 3.

TABLE 3
The Lithium Content of the Material for Positive Electrode of the
Embodiments after Placement.

| | LiCoO₂ | | 25□, 55% RH Air Remaining | | | | |
|---|---|---|---|---|---|---|---|
| | Coating | Lithium | After Placement/% | | | | |
| Experiment | Amount/% | Content/% | 0 h | 50 h | 100 h | 250 h | 500 h |
| Comparison | 0 | 7.11 | 100 | 97.5 | 96.5 | 94.4 | 91.8 |
| Example | | | | | | | |
| Embodiment | 1 | 7.11 | 100 | 97.8 | 96.9 | 95.2 | 93.2 |
| 1 | | | | | | | |
| Embodiment | 5 | 7.10 | 100 | 99.8 | 99.7 | 99.4 | 99.2 |
| 2 | | | | | | | |
| Embodiment | 10 | 7.11 | 100 | 99.8 | 99.8 | 99.6 | 99.5 |
| 3 | | | | | | | |
| Embodiment | 15 | 7.10 | 100 | 99.9 | 99.8 | 99.7 | 99.6 |
| 4 | | | | | | | |

It can be seen from the data in Tables 1, 2 and 3 that, when the amount of the coating is above 5%, the large current discharge characteristics, cycle property, safety property, and storage property of the improved LiNi_{0.8}Co_{0.2}O₂ granules all increased greatly. When the 5 amount of the coating is greater than 10%, the improvement in the properties of the LiNi_{0.8}Co_{0.2}O₂ in not large, but the decrease of its specific discharge capacity is larger.

While the present invention has been described with reference to certain preferred embodiments, it is to be understood that the present invention is not limited to such specific embodiments. Rather, it is the inventor's contention that the invention be understood and 10 construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. Improved lithium nickel cobalt oxide, comprising:
lithium nickel cobalt oxide (LiNi₁₋ₓCoₓO₂) granules and
a layer of lithium cobalt oxide (LiCoO₂) granules coating said lithium nickel cobalt oxide granules.

2. The improved lithium nickel cobalt oxide of claim 1 wherein said lithium nickel cobalt oxide granules having grain diameters of between 6 μm and 10 μm and said lithium cobalt oxide granules having grain diameters of less than 1 μm.

3. The improved lithium nickel cobalt oxide of claim 1 wherein said lithium cobalt oxide granules are between 1 wt. % and 15 wt. % of said lithium nickel cobalt oxide granules.

4. The improved lithium nickel cobalt oxide of claim 1 wherein said lithium cobalt oxide granules are between 5 wt. % and 10 wt. % of said lithium nickel cobalt oxide granules.

5. The improved lithium nickel cobalt oxide of claim 1 wherein 0.15<x<0.30.

6. The improved lithium nickel cobalt oxide of claim 2 wherein said lithium cobalt oxide granules are between 1 wt. % and 15 wt. % of said lithium nickel cobalt oxide granules.

7. The improved lithium nickel cobalt oxide of claim 2 wherein said lithium cobalt oxide granules are between 5 wt. % and 10 wt. % of said lithium nickel cobalt oxide granules.

8. The improved lithium nickel cobalt oxide of claim 6 wherein 0.15<x<0.30.

9. The improved lithium nickel cobalt oxide of claim 7 wherein 0.15<x<0.30.

10. A method for fabricating improved lithium nickel cobalt oxide, comprising the steps of:
mixing Ni₁₋ₓCo_{0.x}(OH)₂ and Li₂CO₃ to form a first mixture;
calcining said first mixture to obtain said LiNi₁₋ₓCoₓO₂ granules;
mixing and dissolving soluble lithium and cobalt salts to form a second mixture;
adding a chelation agent to said second mixture to form a third mixture;
adding said LiNi₁₋ₓCoₓO₂ slowly to said third mixture while stirring;
stirring to obtain a gel;
drying said gel; and
calcining said dried gel to obtain said improved lithium nickel cobalt oxide, LiNi₁₋ₓCoₓO₂ granules coated with LiCoO₂ granules.

11. The method for fabricating said improved lithium nickel cobalt oxide of claim 10 wherein said Ni₁₋ₓCo_{0.x}(OH)₂ having granule diameters between 4 μm and 81 μm.

12. The method for fabricating said improved lithium nickel cobalt oxide of claim 10 wherein 0.15<x<0.30.

13. The method for fabricating said improved lithium nickel cobalt oxide of claim 10 wherein said LiNi₁₋ₓCoₓO₂ granules are added to said third mixture at 60° C. to 1 00° C.

14. The method for fabricating said improved lithium nickel cobalt oxide of claim 10 wherein said LiNi₁₋ₓCoₓO₂ granules are added to said third mixture such that the molar ratio of LiNi₁₋ₓCoₓO₂:LiCoO₂=1: between 0.01 and 0.15.

15. The method for fabricating said improved lithium nickel cobalt oxide of claim 10 wherein said gel is dried at 80° C. to 120° C.

16. The method for fabricating said improved lithium nickel cobalt oxide of claim 10 wherein said dry gel is calcined at 600° C. to 850° C. for 0.5 hours to 2 hours.

17. The method for fabricating said improved lithium nickel cobalt oxide of claim 11 wherein said LiNi₁₋ₓCoₓO₂ granules are added to said third mixture at 60° C. to 100° C.

18. The method for fabricating said improved lithium nickel cobalt oxide of claim 15 wherein said dried gel is calcined at 600° C. to 850° C. for 0.5 hours to 2 hours.

19. The method for fabricating said improved lithium nickel cobalt oxide of claim 11 wherein said gel is dried at 80° C. to 120° C. and said dried gel is calcined at 600° C. to 850° C. for 0.5 hours to 2 hours.

20. A method for fabricating improved lithium nickel cobalt oxide, comprising the steps of:
mixing Ni₁₋ₓCo_{0.x}(OH)₂, where 0.15<x<0.30, and Li₂CO₃ in the molar ratio (Ni+Co): Li=1: 1.05.to form a first mixture wherein said Ni₁₋ₓCo_{0.x}(OH)₂, where 0.15<x<0.30, having granule diameters of between 4 μm and 8 μm;
calcining said first mixture to obtain LiNi₁₋ₓCoₓO₂ granules;
mixing and dissolving soluble lithium and cobalt salts in the molar ratio of Li:Co=1.01: 1 in de-ionized water to form a second mixture;
adding acrylic acid as a chelation agent to said second mixture in the molar ratio of acrylic acid: (Li+Co)=2:1 to form a third mixture;
adding said LiNi₁₋ₓCoₓO₂ granules slowly to said third mixture while stirring at 60° C. to 100° C. such that the final molar ratio of LiNi₁₋ₓCoₓO₂:LiCoO₂=1: between 0.01 and 0.15;
stirring to obtain a gel;
drying said gel at between 80° C. and 120° C.; and
calcining said dried gel in air at 600° C. to 850° C. for 0.5 hours to 2 hours to obtain said improved lithium nickel cobalt oxide, LiNi₁₋ₓCoₓO₂ granules coated with LiCoO₂ granules.
